(19) United States
(12) Patent Application Publication
(10) Pub. No.: US 2025/0356131 A1
(43) Pub. Date: Nov. 20, 2025

(54) Semantic Membership Inference Attack Against Large Language Models

(71) Applicant: Oracle International Corporation, Redwood City, CA (US)

(72) Inventors: Hamid Mozaffari, Seattle, WA (US); Virendra J Marathe, Nashua, NH (US)

(21) Appl. No.: 19/197,416

(22) Filed: May 2, 2025

Related U.S. Application Data
(60) Provisional application No. 63/649,867, filed on May 20, 2024.

(51) Int. Cl. G06F 40/30; G06F 16/334

(52) U.S. Cl. CPC G06F 40/30; G06F 16/3347

(57) ABSTRACT

Systems, methods, and apparatuses may implement a Semantic Model Inference Attack (SMIA) to determine whether a given input text was included in a training data set for a machine learning model, such as a Large Language Model (LLM), according to SMIA scores generated for the given input text and neighbors in a semantic space. An SMIA may generate SMIA scores by generating neighbors of input text in a semantic space, generating embedding vectors and loss values for the input text and neighbors and inputting the vectors and loss values to an attack model trained on loss values of member and non-member data. SMIA scores may then be compared to a threshold to determine whether the input text was used as part of training the machine learning model.

### PRIORITY CLAIM

This application claims benefit of priority to U.S. Provisional Application Ser. No. 63/649,867, entitled “Semantic Membership Inference Attack Against Large Language Models,” filed May 20, 2024, and which is hereby incorporated herein by reference in its entirety.

### BACKGROUND

Machine learning models provide important decision making features for various applications across a wide variety of fields. Given their ubquity, greater importance has been placed on understanding the implications of machine learning model design and training data set choices on machine learning model performance. For example, Large Language Models (LLMs) appear to be effective learners of natural language structure and patterns of usage. However, a contributing factor to their success is their ability to memorize training data. This memorized data can be reproduced verbatim at inference time, giving rise to privacy concerns. While systems and techniques that can provide greater adoption of machine learning models are highly desirable, these approaches must be balanced with effective addressing of these privacy concerns.

### SUMMARY

Large Language Models (LLMs) appear to be effective learners of natural language structure and patterns of usage. However, a contributing factor to their success is their ability to memorize training data which may be reproduced verbatim at inference time, giving rise to privacy concerns. While systems and techniques that can provide greater adoption of machine learning models are highly desirable, these approaches must be balanced with effective addressing of these privacy concerns. Systems, methods, and apparatuses may implement a Semantic Model Inference Attack (SMIA) to determine whether a given input text was included in a training data set for a machine learning model, such as a Large Language Model (LLM), according to SMIA scores generated for the given input text and neighbors in a semantic space. An SMIA may generate SMIA scores by generating neighbors of input text in a semantic space, generating embedding vectors and loss values for the input text and neighbors and inputting the vectors and loss values to an attack model trained on loss values of member and non-member data. SMIA scores may then be compared to a threshold to determine whether the input text was used as part of training the machine learning model.

### BRIEF DESCRIPTION OF THE DRAWINGS

FIG. 1 illustrates a system implementing Semantic Model Inference Attack (SMIA), according to some embodiments.

FIG. 2 illustrates an SMIA attack inference pipeline, according to some embodiments.

FIG. 3 illustrates an example 2-dimensional semantic space, according to some embodiments., according to some embodiments.

FIG. 4 illustrates example algorithm 1, according to some embodiments.

FIG. 5 illustrates example algorithm 2, according to some embodiments.

FIG. 6 is a flow chart detailing an SMIA attack, according to some embodiments.

FIG. 7 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Machine learning models provide important decision making features for various applications across a wide variety of fields. Given their ubquity, greater importance has been placed on understanding the implications of machine learning model design and training data set choices on machine learning model performance. For example, Large Language Models (LLMs) appear to be effective learners of natural language structure and patterns of usage. However, a contributing factor to their success is their ability to memorize training data. This memorized data can be reproduced verbatim at inference time, giving rise to privacy concerns. While systems and techniques that can provide greater adoption of machine learning models are highly desirable, these approaches must be balanced with effective addressing of these privacy concerns.

Membership Inference Attacks (MIAs) may determine whether specific data was included in a training set of a target model. In at least one embodiment, a Semantic Membership Inference Attack (SMIA) is described that enhances MIA performance by leveraging the semantic content of inputs and their perturbations. SMIA trains a neural network to analyze the target model's behavior on perturbed inputs, effectively capturing variations in output probability distributions between members and non-members.

Large Language Models (LLMs) appear to be effective learners of natural language structure and patterns of its usage. However, a contributing factor to their success is their ability to memorize their training data, often verbatim. This memorized data can be reproduced intact at inference time, which may be beneficial for information retrieval is also at the heart of privacy concerns in LLMs which may leak some of their training data at inference time. Membership Inference Attacks (MIAs) aim to determine whether a specific data sample (e.g. sentence, paragraph, document) was part of the training set of a target machine learning model. MIAs serve as efficient tools to measure memorization in LLMs.

MIAs provide essential assessments in various domains. They are cornerstone for privacy auditing where they test whether LLMs leak sensitive information, thereby ensuring models do not memorize data beyond their learning scope. In the realm of machine unlearning, MIAs are instrumental in verifying the efficacy of algorithms to comply with the right to be forgotten, as provided by privacy laws like the General Data Protection Regulation (GDPR) and the California Consumer Privacy Act (CCPA)]. These attacks are also pivotal in copyright detection, pinpointing the unauthorized inclusion of copyrighted material in training datasets. Furthermore, they aid in detecting data contamination—where specific task data might leak into a model's general training dataset. Lastly, in the tuning of hyperparameters, variables that control how machine learning models learn, for differential privacy, MIAs may provide insights for setting the e parameter (i.e., the privacy budget), which dictates the trade-off between a model's performance and user privacy.

Some approaches to measure memorization in LLMs have predominantly focused on verbatim memorization, which involves identifying exact sequences reproduced from the training data. However, given the complexity and richness of natural language, this method is often insufficient. Natural language may represent the same ideas or sensitive data in numerous forms, through different levels of indirection and associations. This power of natural language makes verbatim memorization metrics inadequate to address the more nuanced problem of measuring semantic memorization, where LLMs internalize and reproduce the essence or meaning of training data sequences, not just their exact wording.

Previous MIAs have predominantly focused on classifying members, or data belonging to the training set of an LLM, and non-members, or data excluded from the training set of an LLM, by analyzing the probabilities assigned to input texts or their perturbations. In contrast, the Semantic Membership Inference Attack (SMIA) techniques described herein provide the first MIA to leverage the semantic content of input texts to enhance performance. SMIA involves training a neural network to understand the distinct behaviors exhibited by the target model or LLM when processing members versus non-members.

Perturbing the input of a target model will result in differential changes in its output probability distribution for members and non-members, contingent on the extent of semantic change distance. This behavior can be learnable. To implement this, an SMIA model may be trained to discern how the target model's behavior varies with different degrees of semantic changes for members and non-members. Post-training, the model can classify a given text sequence as a member or non-member by evaluating the semantic distance and the corresponding changes in the target model's behavior for the original input and its perturbations.

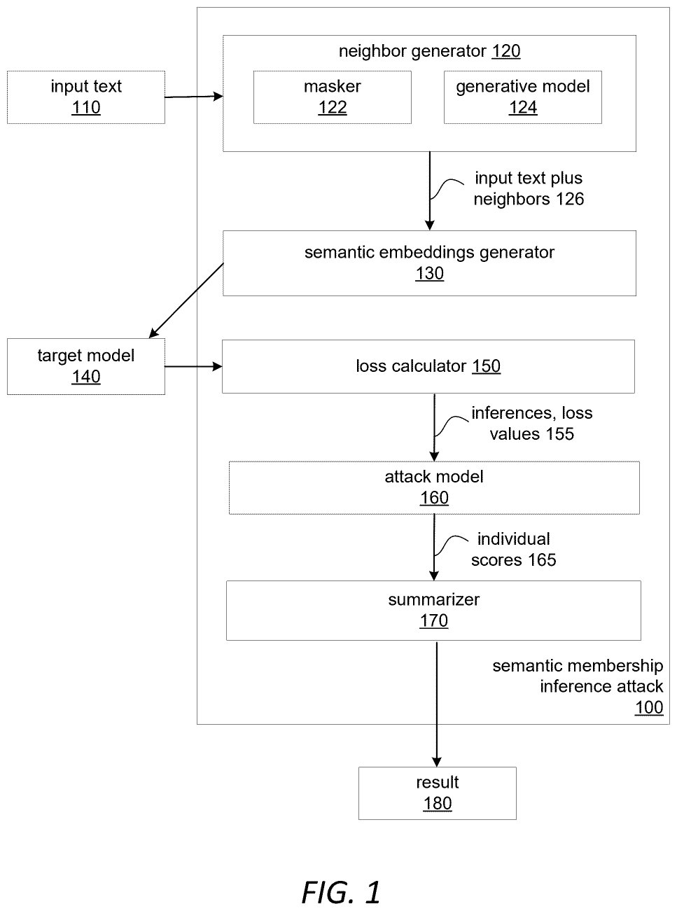

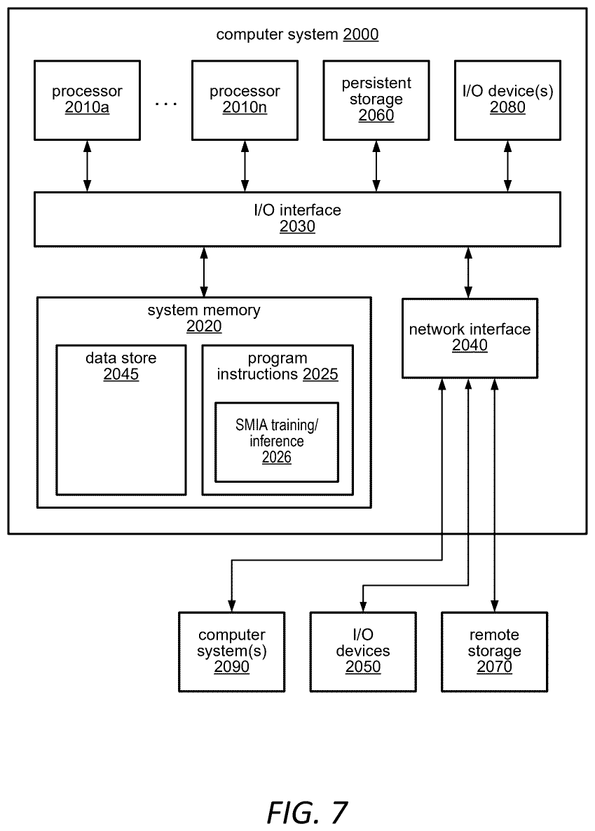

FIG. 1 illustrates a system implementing Semantic Model Inference Attack (SMIA), according to some embodiments. In at least one embodiment, an SMIA 100 may receive input text 110 to determine whether the input text was included in training data for a target model 140. The SMIA may be implemented using a computer system or distributed computer system such as described below in FIG. 7. SMIA 100 may include a neighbor generator 120 that perturbs the input text 110 a number of times by randomly masking different positions using a masker 122 and filling the different positions using a generative model 124. In some embodiments, this masking and generating may be performed by a single mask model while in other embodiments masking and generating may be performed in separate steps using one or more machine learning models. In at least one embodiment, the results in generated neighbors that are combined with input text and used as input 126 to a semantic embeddings generator or model 130. In at least one embodiment, semantic embeddings for the input text and generated neighbors may then be submitted to a target model 140.

In at least one embodiment, inferences from target model 140 may then be input to loss calculator 150 where loss values of the target model for the input text and its neighbors may be calculated. Then the inferences and determined loss values 155 may be input to a trained SMIA attack model 160 to estimate the membership probabilities or SMIA scores 165. These scores 165 may then be summarized 170 in various embodiments, such as by averaging and comparing the average against a predefined threshold to classify the input as a member or non-member. This classification may then be output as result 180.

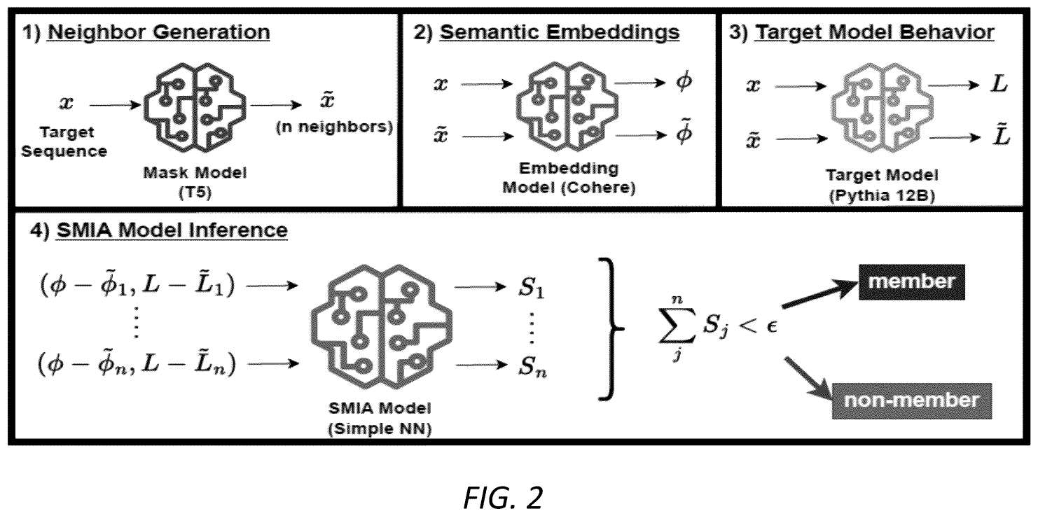

FIG. 2 1 illustrates a pipeline of SMIA inference, according to some embodiments. In at least one embodiment, an SMIA inference pipeline, such as SMIA 100 in FIG. 1, for a given text x, such as input text 110 of FIG. 1, and a target model T(⋅), such as target model 140 of FIG. 1, may include the following four steps. A neighbor generation step, such as neighbor generator 120 of FIG. 1, may alter or perturb text x a number n times by randomly masking different positions and filling them using a masking and generative models T5, such as masker 122 and generative model 124 of FIG. 1, to generate a neighbor dataset x^{˜}. Then, in at least one embodiment semantic embeddings may be for text x and neighbor dataset x^{˜} using an embedding model. The semantic embeddings of the input text and its neighbors are computed by using an embedding model, such as Cohere Embedding model.

In at least one embodiment, semantic embeddings of the input text and its neighbors may then be submitted to target model T(⋅) and resulting inferences processed to determine loss values of the target model for the input text and its neighbors, such as by loss calculator 150 of FIG. 1. Then, in at least one embodiment a trained SMIA model, such as attack mode 160 of FIG. 1, may then be used to estimate membership probabilities. In at least one embodiment, these scores may then be averaged and compared against a predefined threshold to classify the input as a member or non-member, such as by summarizer 170 of FIG. 1.

The performance of SMIA may be evaluated across different model families, specifically Pythia and GPT-Neo, using the Wikipedia dataset. To underscore the significance of the non-member dataset in evaluating MIAs, two distinct non-member datasets in our analysis: one derived from the exact distribution of the member dataset and another comprising Wikipedia pages published after a cutoff date, which exhibit lower n-gram similarity with the members. Additionally, SMIA may be assessed under two settings: (1) verbatim evaluation, where members exactly match the entries in the target training dataset, and (2) slightly modified members, where one word is either duplicated, added, or deleted from the original member data points.

These results demonstrate that SMIA consistently outperforms all existing MIAs by a substantial margin. For instance, SMIA achieves an AUC-ROC of 67.39% for Pythia-12B on the Wikipedia dataset. In terms of True Positive Rate (TPR) at low False Positive Rate (FPR), SMIA achieves TPRs of 3.8% and 10.4% for 2% and 5% FPR, respectively, on the same model. In comparison, the second-best attack, the Reference attack, achieves an AUC-ROC of 58.90%, with TPRs of 1.1% and 6.7% for 2% and 5% FPR, respectively.

MIAs seek to determine whether a specific data sample was part of the training set of a machine learning model, highlighting potential privacy risks associated with model training. Traditional MIAs typically verify if a text segment, ranging from a sentence to a full document, was used exactly as is in the training data. Such attacks tend to falter when minor modifications are made to the text, such as punctuation adjustments or article substitutions, while the overall meaning remains intact. However, it may be appreciated that an LLM, having encountered specific content during training, will exhibit similar behaviors towards semantically similar text snippets during inference. Consequently, an LLM's response to semantically related inputs should display notable consistency.

As noted above, a Semantic Membership Inference Attack (SMIA) against LLMs is described. This attack technique enables an attacker to discern whether a concept, defined as a set of semantically akin token sequences, was part of the training data. Examples of such semantically linked concepts include “John Doe has leukemia” and “John Doe is undergoing chemotherapy.” The SMIA aims to capture a broader spectrum of data memorization incidents compared to traditional MIA, by determining whether the LLM was trained on any data encompassing the targeted concept.

For the SMIA, it may be assumed that the adversary has grey-box access to the target LLM, denoted as T(x), which is trained on an unknown dataset Dₜᵣₐᵢₙ. The adversary can obtain loss values or log probabilities for any input text from this model, denoted as [symbol] (⋅, T), but lacks additional information such as model weights or gradients. SMIA may provide distinguishable behavior modification exhibited by the target model when presented with semantic variants of member and non-member data points.

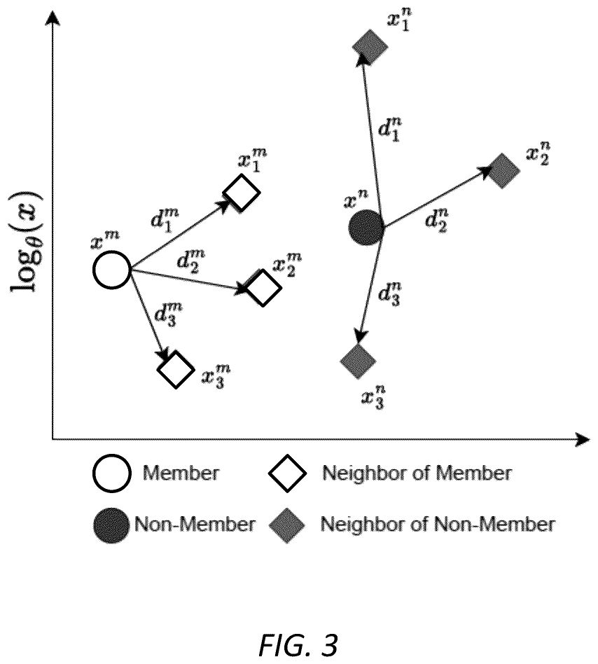

As illustrated in FIG. 3, consider a two-dimensional semantic space populated by data points. Members and non-members are represented by empty circles and filled circles, respectively. By generating semantic neighbors for both member and non-member data points (shown as empty and filled diamonds, respectively), a measure of semantic disparity between targeted data points and their neighbors, may be denoted as

$${d}_{i}^{m} and {d}_{i}^{n} .$$

Subsequently, we may observe the target model's response to these data points by assessing differences in loss values, thereby training the SMIA to classify data points as members or non-members based on these observed patterns.

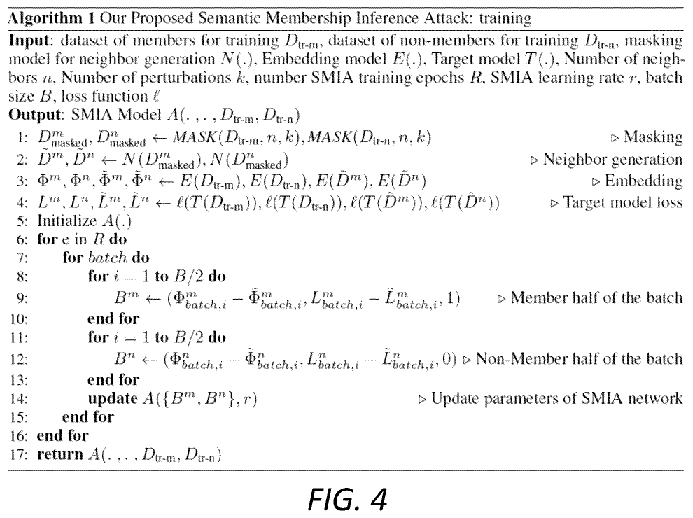

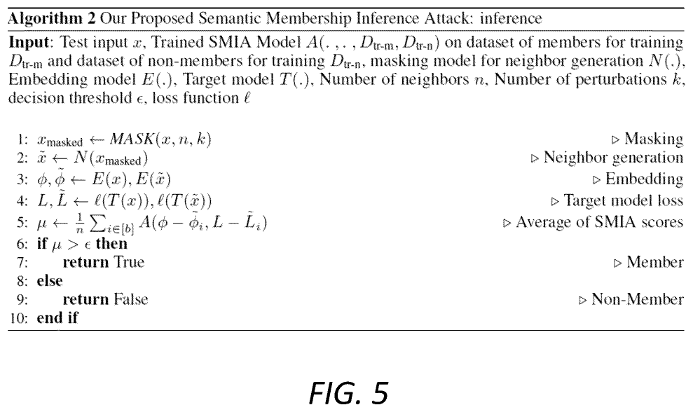

An SMIA may include two stage, a training stage and an inferencing stage. First, an adversary may train a neural network model A(⋅) on a dataset gathered for this purpose, and then the trained model for inference. The training and inference processes are detailed in Algorithms 1 and 2, respectively illustrated in FIGS. 4 and 5.

During the training phase, the adversary collects two distinct datasets: Dtr-m (member dataset) and Dtr-n (non-member dataset). Dtr-m comprises texts known to be part of the training dataset of the target model T( ), while Dtr-n includes texts confirmed to be unseen by the target model during training. The adversary utilizes these datasets to develop a membership inference model capable of distinguishing between members (∈Dtr-m) and non-members (∈Dtr-n). For instance, Wikipedia articles or any publicly available data collected before a specified cutoff date are commonly part of many known datasets. Data collected after this cutoff date can be reliably assumed to be absent from the training datasets. The adversary needs these two datasets to train a membership inference model where it can separate the members (∈Dtr-m) and non-members (∈Dtr-n).

In at least one embodiment, an SMIA training procedure, shown in Algorithm 1 of FIG. 4, includes the following key stages. First, in at least one embodiment neighbors may be generated (Algorithm 1 lines 1-2), such as by neighbor generator 120 of FIG. 1. This initial phase of SMIA involves generating a dataset of neighbors for both the member dataset (Dtr-m) and the non-member dataset (Dₜᵣ₋ₙ). The creation of a neighbor entails making minimal changes to a data item that fully preserve its semantics and grammar, thereby ensuring that these neighbors are semantically equivalent to the original sample and should be assigned a highly similar likelihood under any textual probability distribution. Specifically, Algorithm 1 line 1 describes the creation of masked versions of

$${D}_{masked}^{D} and {D}_{masked}^{n}$$

by randomly replacing k words within each text item n times. Following this, in line 2, a neighbor generator model N(x, L, K)—a masking model—is employed to refill these masked positions, generating datasets \tilde{D}m and \tilde{D}n for members and non-members, respectively. Utilize a model, such as the T5 model in the experiments to perform these replacements, aiming to produce n semantically close variants of each data point.

Then, in at least one embodiment semantic embeddings of the data points may be calculated (Algorithm 1 line 3), such as by semantic embeddings generator 130 of FIG. 1. This step involves computing semantic embeddings for both the original data points and their neighbors. As per Algorithm 1 line 3, obtain the embedding vectors ϕ^{m}←E(Dₜᵣ₋ₘ) and ϕⁿ←E(Dₜᵣ₋ₙ) for the member and non-member data points, respectively. Additionally, calculate \tilde{ϕ}^{m}←E(\tilde{D}^{m}) and \tilde{ϕ}ⁿ←E(\tilde{D}ⁿ) for their respective neighbors. These vectors represent each data point's position in a semantic space encompassing all possible inputs. In some embodiments, the Cohere Embedding may be leveraged V3 model may be used, which provides embeddings with 1024 dimensions, to capture these semantic features.

Then, in at least one embodiment behavior of the target model for different inputs may be monitored (Algorithm 1 line 4). This step entails monitoring the target model's response across the four datasets. Here, a loss calculator, such as loss calculator 150 of FIG. 1, may calculate the loss values: L^{m}← [symbol] (T(Dₜᵣ₋ₘ)) for the member dataset, Lⁿ← [symbol] (T(Dₜᵣ₋ₙ)) for the non-member dataset, and similarly \tilde{L}^{m}← [symbol] (T(\tilde{D}^{m})) and \tilde{L}ⁿ← [symbol] (T(\tilde{D}ⁿ)) for their respective neighbor datasets. This step may allow for understanding how a target model's behavior varies between members and non-members under semantically equivalent perturbations.

Then, in at least one embodiment an attack model may be trained (Algorithm 1 lines 5-16): This phase of training involves developing a binary neural network capable of distinguishing between members and non-members by detecting patterns of semantic and behavioral changes induced by the perturbations. An attack model A may be randomly initialized, then trained to discern differences between the semantic embeddings and loss values for each data point and its neighbors. The input features for A include differences in semantic vectors

$${Φ}_{i}^{m} - {\tilde{Φ}}_{i}^{m}$$

and the changes in loss values

$${L}_{i}^{m} - {\tilde{L}}_{i}^{m}$$

for each sample i. Each sample is labeled ‘1’ for members and ‘0’ for non-members, with each training batch consisting of an equal mix of both. The model is trained over R epochs using a learning rate r, culminating in a trained binary classifier that effectively distinguishes between members and non-members based on the observed data.

Upon completing the training of the model A(⋅), the model may be employed to assess whether a given input text x was part of the target model T( )'s training dataset. As shown in FIG. 5, algorithm 2 details the inference procedure which mirrors the training process. Initially, n_{inf} neighbors for x are generated using the mask model (Algorithm 1 lines 1-2). Subsequently, compute both the semantic embedding vectors and the loss values for x and its neighbors \tilde{x} (Algorithm 1 lines 3-4). These computed differences are then fed into the attack model A(ϕ˜\tilde{ϕ}ⱼ, L−\tilde{L}ⱼ), which evaluates each neighbor j. The final SMIA score for x is determined by averaging the scores from all n_{inf} neighbors (Algorithm 1 line 5), and this score is compared against a predefined threshold e to ascertain membership or non-membership (Algorithm 1 line 6).

In at least one embodiment, cost estimation for deploying the SMIA may involve several computational and resource considerations. Primarily, the cost is associated with generating neighbors, calculating embeddings, and evaluating loss values for the target model T(⋅).

For each of the datasets, Dₜᵣ₋ₘ (members) and Dₜᵣ₋ₙ (non-members), consisting of β data samples each, we generate n neighbors per data item. Consequently, this results in a total of 2×n×β neighbor generations. Assuming each operation has a fixed cost, with c_{N} for generating a neighbor, c_{T} for computing a loss value, and c_{E} for calculating an embedding, the total cost for the feature collection phase can be approximated as: 2×(n×β+1)×(c_{N}+c_{E}+c_{T}). In this estimation, the training of the neural network model A(⋅) is considered negligible due to its relatively small size (few million parameters) and its architecture, which primarily consists of fully connected layers. Additionally, the costs associated with c_{T} and c_{N} are not significant in this context as they are incurred only during the inference phase. Thus, the predominant cost factor is c_{E}, the cost of embedding calculations.

In practical terms, an embodiment may be setup using the Wikipedia dataset as an example, preparing a training set comprising 6,000 members and 6,000 non-members. With each data item generating n=25 neighbors, the total number of data items requiring embedding calculations becomes: 6,000+6,000+150,000+150,000=312,000 in this example. Each of these data items, on average, consists of 1052 characters (variable due to replacements made by the neighbor generation model), leading to a total of 312,000×1052=328,224,000 characters processed. These transactions are sent to a Cohere Embedding V3 model for embedding generation. The cost of processing these embeddings is measured in thousands of units. Hence, the total estimated cost for embedding processing is approximately: 32,822×$0.001=$32.82.

In various embodiments, the Semantic Membership Inference Attack (SMIA), which leverages the semantics of input texts and their perturbations to train a neural network for distinguishing members from non-members. SMIA may be evaluated in different settings: (1) where the test member dataset exists verbatim in the training dataset of the target model, and (2) where the test member dataset is slightly modified through the addition, duplication, or deletion of a single word. In some embodiments, SMIA may be implemented in settings where the test member dataset consists of paraphrases of the original member data points, with minimal semantic distance between them. This will help demonstrate that more advanced models tend to memorize the semantics of their training data rather than their exact wording. In some embodiments, SMIA may be applied to measure unintended multi-hop reasoning. In multi-hop reasoning, a model could connect two parts of the training data through indirect inferences, potentially disclosing private information. How much the target model reveals about its training data through multi-hop reasoning may be shown, in some embodiments, using the SMIA technique. In some embodiments, SMIA may be implemented to show that anonymization is insufficient. SMIA can reveal the limitations of traditional data redaction techniques, illustrating how anonymization falls short when an adversary can cross-reference (e.g., use supplementary information from another source) to deduce sensitive information, such as a person's medical condition. In some embodiments, SMIA can be used to measure hallucination in LLMs. Hallucination and memorization may be interconnected in some scenarios. Intuitively, the more an LLM memorizes its training data, the less likely it is to hallucinate text that contradicts the memorized data. SMIA can provide a metric for assessing the likelihood of text output being a result of the model's accurate memorization (direct or multi-hop) versus hallucination. This metric is particularly valuable as it measures the extent to which an output is derived from the model's intrinsic semantic beliefs, shaped by its training data.

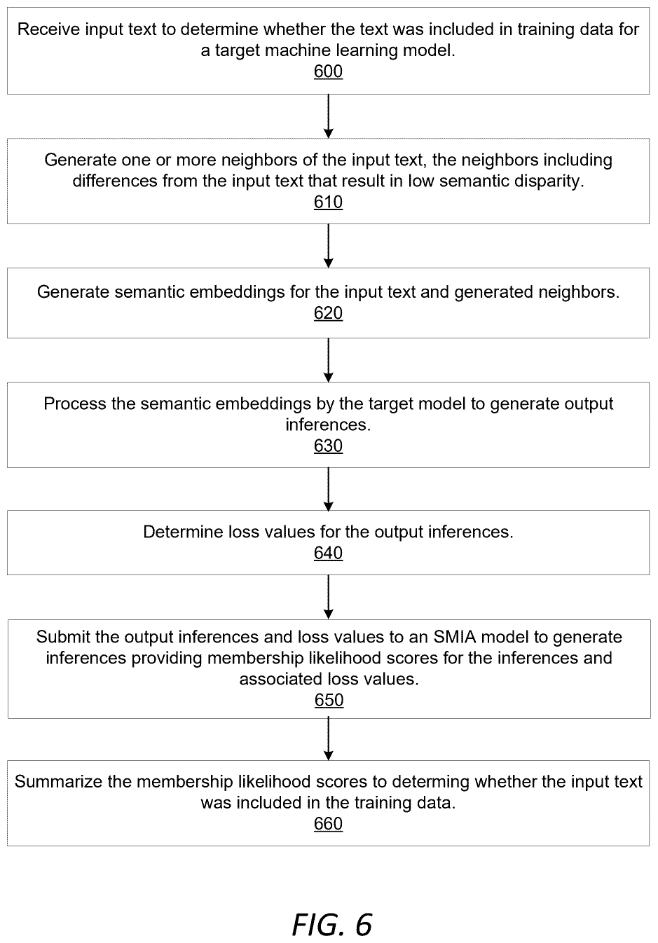

FIG. 6 is a flow chart detailing an SMIA attack, according to some embodiments. In at least one embodiment, the process may begin at 600 when an SMIA receives input text, such as input text 110 of FIG. 1, to determine whether the text was included in, or not included in, training data for a target machine learning model, such as target model 140 of FIG. 1. Then, as shown in 610, an SMIA, such as SMIA 100 of FIG. 1, may generate one or more neighbors of the input text, such as by neighbor generator 120 of FIG. 1. In at least one embodiment, this generating entails making minimal changes to a data item that preserve its semantics and grammar, thereby ensuring that these neighbors are semantically equivalent to the original sample and should be assigned a highly similar likelihood under any textual probability distribution, thus resulting in a low semantic disparity between the input text and generated neighbors. Specifically, masked versions on the input text may be created by randomly replacing k words within the input text n times. Following this, a neighbor generator model N(x, L, K)—a masking model—may be employed to refill these masked positions. This generating may produce n semantically close variants of the input text, in at least one embodiment.

Then, as shown in 620, in at least one embodiment semantic embeddings for the input text and generated neighbors may be generated, such as by semantic embeddings generator 130 of FIG. 1. These semantic embeddings represent each data point's position in a semantic space encompassing all possible inputs. In some embodiments, the Cohere Embedding may be leveraged V3 model may be used, which provides embeddings with 1024 dimensions, to capture these semantic features. However, this is merely one example of a semantic embeddings generator and any number of semantic embeddings generators may be envisioned, in various embodiments.

Then, as shown in 630, in at least one embodiment the semantic embeddings of the input text and neighbors may be submitted to the target model to generate output inferences. These output inferences may be input to a loss calculator, such as loss calculator 150 of FIG. 1, as shown in 640 to determine loss values for the various output inferences. These calculations characterize the target model's behavior for the input text and semantically equivalent perturbations of the input text.

Then, as shown in 630, in at least one embodiment the inferences and computed losses are then fed into the attack model such as attack model 160 of FIG. 1. The attack mode may then generate inferences that represent membership likelihood scores for each of the input text and generated neighbors. Then, as shown in 640, in at least one embodiment a final SMIA score may be determined by averaging the membership likelihood scores and this average score compared against a predefined threshold e to ascertain membership or non-membership.

The mechanisms for implementing subject level privacy attack analysis for federated learning, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

FIG. 7 illustrates a computing system configured to implement the methods and techniques described herein, according to various embodiments. The computer system 2000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device. Any of various computer systems may be configured to implement processes associated with a technique for multi-region, multi-primary data store replication as discussed with regard to the various figures above. FIG. 7 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 7 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for SMIA training and inference as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 16 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

Those skilled in the art will appreciate that computer system 2000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 2000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to another computer system via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to implement a Semantic Membership Inference Attack (SMIA) configured to:
receive an input text to determine whether the input text was used as part of training a target language model;
generate respective semantic embedding vectors and respective loss values for the input text and one or more generated neighbors of the input text;
input the respective semantic embedding vectors and respective loss values for the input text and the one or more generated neighbors into an attack model trained according to SMIA training technique; and
determine an SMIA score for the input text based at least in part on average scores generated using the attack model for the one or more generated neighbors to determine whether the input text was used as part of training the target language model.

2. The system of claim 1, wherein the one or more neighbors individually comprise text different from the input text and semantically equivalent to the input text.

3. The system of claim 1, wherein to generate the one or more generated neighbors, the SMIA is configured to identify one or more words of the input text that, when altered, generate low semantic disparity with respect to the input text.

4. The system of claim 3, wherein to generate an individual neighbor of the one or more generated neighbors the SMIA is configured to replace the one or more identified words using a mask model.

5. The system of claim 1, wherein the SMIA is further configured to train the attack model according to the SMIA training technique.

6. The system of claim 1, wherein to train the attack model trained according to the SMIA training technique the SMIA is configured to train the attack model according to generated respective loss values for other text and generated neighbors of the other text, the other text comprising data used as part of training the target language model and data not used as part of training the target language model.

7. The system of claim 1, wherein the SMIA is further configured to compare the determined SMIA score to a threshold value to determine whether the input text was used as part of training the target language model.

8. A computer-implemented method, comprising:
receiving an input text to determine whether the input text was used as part of training a target language model;
generating respective semantic embedding vectors and respective loss values for the input text and one or more generated neighbors of the input text;
inputting the respective semantic embedding vectors and respective loss values for the input text and the one or more generated neighbors into an attack model trained according to Semantic Membership Inference Attack (SMIA) training technique; and
determining an SMIA score for the input text based at least in part on average scores generated using the attack model for the one or more generated neighbors to determine whether the input text was used as part of training the target language model.

9. The computer-implemented method of claim 8, wherein the one or more neighbors individually comprise text different from the input text and semantically equivalent to the input text.

10. The computer-implemented method of claim 8, wherein generating the one or more generated neighbors comprises identifying one or more words of the input text that, when altered, generate low semantic disparity with respect to the input text.

11. The computer-implemented method of claim 10, further comprising replacing the one or more identified words using a mask model to generate an individual neighbor of the one or more generated neighbors.

12. The computer-implemented method of claim 8, further comprising training the attack model according to the SMIA training technique.

13. The computer-implemented method of claim 8, further comprising training the attack model according generated respective loss values for other text and generated neighbors of the other text, the other text comprising data used as part of training the target language model and data not used as part of training the target language model.

14. The computer-implemented method of claim 8, further comprising comparing the determined SMIA score to a threshold value to determine whether the input text was used as part of training the target language model.

15. One or more non-transitory, computer-readable storage media, storing program instructions that when executed on or across one or more computing devices, cause the one or more computing devices to implement a Semantic Membership Inference Attack (SMIA) to perform:
receiving an input text to determine whether the input text was used as part of training a target language model in a training data set;
generating respective semantic embedding vectors and respective loss values for the input text and one or more generated neighbors of the input text;
providing the respective semantic embedding vectors and respective loss values for the input text and the one or more generated neighbors as input into an attack model trained according to Semantic Membership Inference Attack (SMIA) training technique; and
determining an SMIA score for the input text based at least in part on average scores generated using the attack model for the one or more generated neighbors to determine whether the input text was used as part of training the target language model in the training data set.

16. The one or more non-transitory, computer-readable storage media of claim 15, wherein the one or more neighbors individually comprise text different from the input text and semantically equivalent to the input text.

17. The one or more non-transitory, computer-readable storage media of claim 15, wherein generating the one or more generated neighbors comprises identifying one or more words of the input text that, when altered, generate low semantic disparity with respect to the input text.

18. The one or more non-transitory, computer-readable storage media of claim 17, wherein the SMIA further performs replacing the one or more identified words using a mask model to generate an individual neighbor of the one or more generated neighbors.

19. The one or more non-transitory, computer-readable storage media of claim 15, wherein the SMIA further performs training the attack model using according generated respective loss values for other text and generated neighbors of the other text, the other text comprising data used as part of training the target language model and data not used as part of training the target language model.

20. The one or more non-transitory, computer-readable storage media of claim 15, wherein the SMIA further performs comparing the determined SMIA score to a threshold value to determine whether the input text was used as part of training the target language model.
